(19) United States
(12) Patent Application Publication
(10) Pub. No.: US 2007/0026316 A1
(43) Pub. Date: Feb. 1, 2007

(54) Non-aqueous electrolyte battery

(75) Inventors: Naoki Imachi, Kobe-shi (JP); Hiroyuki Fujimoto, Kobe-shi (JP); Shin Fujitani, Kobe-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-shi (JP)

(21) Appl. No.: 11/492,759

(22) Filed: Jul. 26, 2006

(30) Foreign Application Priority Data
Jul. 28, 2005 (JP) 2005-218420

(51) Int. Cl. H01M 4/62; H01M 4/58; H01M 4/52

(52) U.S. Cl. 429/232; 429/128; 429/231.95; 429/223; 429/224; 429/221; 429/231.3

(57) ABSTRACT

A non-aqueous electrolyte battery is provided that achieves an improvement in safety, particularly an improvement in tolerance of the battery to overcharging, and also prevents discharge capacity from degrading, without compromising conventional battery designs considerably. The non-aqueous electrolyte battery has a positive electrode including a positive electrode active material-layer stack and a positive electrode current collector, a negative electrode including a negative electrode active material layer, and a separator interposed between the electrodes. The positive electrode active material-layer stack has two layers respectively having different positive electrode active materials. Of the two layers, a first positive electrode active material layer (11) that is nearer the positive electrode current collector (16) contains an olivine-type lithium phosphate compound as its positive electrode active material and uses VGCF (18) as a conductivity enhancing agent.

### BACKGROUND OF THE INVENTION

1. Field of the Invention

The present invention relates to improvements in non-aqueous electrolyte batteries, such as lithium-ion batteries and polymer batteries, and more particularly to non-aqueous electrolyte batteries that have excellent safety on overcharge.

2. Description of Related Art

Rapid advancements in size and weight reductions of mobile information terminal devices such as mobile phones, notebook computers, and PDAs in recent years have created demands for higher capacity batteries as driving power sources for the devices. With their high energy density and high capacity, non-aqueous electrolyte batteries that perform charge and discharge by transferring lithium ions between the positive and negative electrodes have been widely used as the driving power sources for the mobile information terminal devices. Moreover, utilizing their characteristics, applications of non-aqueous electrolyte batteries, especially Li-ion batteries, have recently been broadened to middle-sized and large-sized batteries for power tools, electric automobiles, hybrid automobiles, etc., as well as mobile applications such as mobile phones. As a consequence, demands for increased battery safety have been on the rise, along with demands for increased capacity and higher output power.

Many of commercially available non-aqueous electrolyte batteries, especially Li-ion batteries, adopt lithium cobalt oxide as their positive electrode active material. The energy that can be attained by lithium cobalt oxide, however, has almost reached the limit already; therefore, to achieve higher battery capacity, it has been inevitable to increase the filling density of the positive electrode active material. Nevertheless, increasing the filling density of the positive electrode active material causes battery safety to degrade when the battery is overcharged. In other words, since there is a trade-off between improvement in battery capacity and enhancement in battery safety, improvements in capacity of the battery have lately made little progress. Even if a new positive electrode active material that can serve as an alternative to lithium cobalt oxide will be developed in the future, the necessity of increasing the filling density of the positive electrode active material to achieve a further higher capacity will still remain the same because the energy that can be attained by that newly developed active material will also reach the limit sooner or later.

Conventional unit cells incorporate various safety mechanisms such as a separator shutdown function and additives to electrolyte solutions, but these mechanisms are designed assuming a condition in which the filling density of active material is not very high. For that reason, increasing the filling density of active material as described above brings about such problems as follows. Since the electrolyte solution's infiltrating performance into the interior of the electrodes is greatly reduced, reactions occur locally, causing lithium to deposit on the negative electrode surface. In addition, the convection of electrolyte solution is worsened and heat is entrapped within the electrodes, worsening heat dissipation. These prevent the above-mentioned safety mechanisms from fully exhibiting their functions, leading to further degradation in safety. Thus, it is necessary to establish a battery design that can make full use of those safety mechanisms without considerably compromising conventional battery designs.

To resolve the foregoing problems, various techniques have been proposed. For example, Japanese Published Unexamined Patent Application No. 2001-143705 proposes a Li-ion secondary battery that has improved safety using a positive electrode active material in which lithium cobalt oxide and lithium manganese oxide are mixed. Japanese Published Unexamined Patent Application No. 2001-143708 proposes a Li-ion secondary battery that improves storage performance and safety using a positive electrode active material in which two layers of lithium-nickel-cobalt composite oxides having different compositions are formed. Japanese Published Unexamined Patent Application No. 2001-338639 proposes a Li-ion secondary battery in which, for the purpose of enhancing battery safety determined by a nail penetration test, a plurality of layers are formed in the positive electrode and a material with high thermal stability is disposed in the lowermost layer of the positive electrode, to prevent the thermal runaway of the positive electrode due to heat that transfers via the current collector to the entire battery.

The above-described conventional batteries have the following problems.

(1) JP 2001-143705A

Merely mixing lithium cobalt oxide and lithium manganese oxide cannot fully exploit the advantage of lithium manganese oxide, which has excellent safety. Therefore, an improvement in safety cannot be attained.

(2) JP 2001-143708A

Lithium-nickel-cobalt composite oxide has lithium ions that can be extracted from the crystals during overcharge abundantly in the crystals. Since the lithium can deposit on the negative electrode and become a source of heat generation, it is difficult to improve the safety during overcharge and the like sufficiently. (

3) JP 2001-338639A

The above-described construction is intended for merely preventing the thermal runaway of a battery due to heat dissipation through the current collector under a certain voltage, and is not effective in preventing the thermal runaway of an active material that originates from deposited lithium on the negative electrode such as when overcharged. (The details will be discussed later.)

### BRIEF SUMMARY OF THE INVENTION

Accordingly, it is an object of the present invention to provide a non-aqueous electrolyte battery that achieves improvements in safety, particularly improvements in tolerance of a battery to overcharging, and moreover is capable of preventing the discharge capacity from degrading, without compromising the conventional battery designs considerably.

In order to accomplish the foregoing and other objects, the present invention provides a non-aqueous electrolyte battery comprising: a positive electrode including a positive electrode active material-layer stack and a positive electrode current collector, the positive electrode active material-layer stack being formed on a surface of the positive electrode current collector and comprising a plurality of layers respectively having a plurality of different positive electrode active materials, wherein, among the plurality of layers, at least one layer other than the outermost positive electrode layer contains as its main active material a positive electrode active material having the highest resistance increase rate during overcharge among the positive electrode active materials, and the at least one layer containing as its main active material the positive electrode active material having the highest resistance increase rate contains a fibrous carbon material as a conductivity enhancing agent; a negative electrode including a negative electrode active material layer; and a separator interposed between the electrodes.

When, as in the foregoing construction, at least one layer other than the outermost positive electrode layer contains as its main active material the positive electrode active material having the highest resistance increase rate during overcharge, the current collection performance lowers in the outermost positive electrode layer that has a high reactivity during overcharge (more specifically, in the layer(s) nearer the electrode surface than is the high resistance-increase layer), and consequently, the active material of the outermost positive electrode layer(s) is not easily charged to the charge depth that should reach otherwise. Accordingly, the amount of lithium deintercalated from the positive electrode in the overcharge region (especially the amount of the lithium deintercalated from the outermost positive electrode layer) decreases, reducing the total amount of lithium deposited on the negative electrode. Consequently, the amount of heat produced due to the reaction between the electrolyte solution and the lithium deposited on the negative electrode correspondingly reduces, thereby preventing the deposition of dendrite. Moreover, the thermal stability of the positive electrode active material (particularly of the active material in the outermost positive electrode layer that becomes instable because of the extraction of lithium from the crystals) is also kept relatively high because the charge depth does not become deep; therefore, the reaction between the positive electrode active material and the excessive electrolyte solution existing in the separator etc. can be inhibited. For the above reasons, the tolerance of the battery to overcharging can be improved.

Furthermore, the use of the fibrous carbon material as the conductivity enhancing agent in the layer containing as the main active material the positive electrode active material having the highest resistance increase rate enables the battery to improve the tolerance of the battery to overcharging more effectively while preventing the battery capacity from degrading. The reason is as follows.

Generally, the positive electrode active materials having high resistance increase rates during overcharge (such as olivine-type lithium phosphate compounds) show less discharge capacities per unit mass (lower energy densities) than the positive electrode active materials having low resistance increase rates during overcharge (such as lithium cobalt oxide). Accordingly, from the viewpoint of improvement in energy density, it is desirable that the thickness of the layer having a high resistance increase rate during overcharge (hereinafter also referred to as a “high resistance-increase layer”) be made as thin as possible.

In this case, however, a problem arises if the high resistance-increase layer contains a commonly-used conductivity enhancing agent that has a large particle size, because such conductivity enhancing agent serves to form conductive paths easily between a layer that is nearer the positive electrode current collector than is the high resistance-increase layer (the positive electrode current collector when the high resistance-increase layer is in contact with the positive electrode current collector) and a layer that is nearer the electrode surface than is the high resistance-increase layer, which locally weakens the effect of the resistance increase in the high resistance-increase layer during overcharge. Another problem is as follows. Electric current concentrates at the locations where the conductive paths are established, inducing local thermal runway reactions or the like in the layer being nearer the electrode surface than is the high resistance-increase layer and containing a positive electrode active material having a lower resistance increase rate during overcharge. Therefore, the effect of the high tolerance of the battery to overcharging cannot be fully exhibited.

In view of the problems, a fibrous carbon material (such as VGCF) is used as the conductivity enhancing agent of the high resistance-increase layer, as in the foregoing construction. The fibrous carbon material shows better dispersion capability and higher conductivity than conventional conductivity enhancing agents, such as SP300 and acetylene black, so its function as a conductivity enhancing agent is excellent. Moreover, the fibrous carbon material has a very small fiber diameter (for example, the fiber diameter of VGCF is about 150 nm), and therefore, the fibrous carbon material does not easily form conductive paths even if the thickness of the high resistance-increase layer is small. It is possible that conductive paths might be formed since the length of the fibrous carbon material is greater than the fiber diameter (fiber length: about 9 μm). However, after the active material slurry is applied to the surface of the positive electrode current collector, a process of compressing the active material slurry is necessarily carried out in order to increase the filling efficiency of the positive electrode active material. This compression causes the fibrous carbon material to orient in a direction substantially parallel to the positive electrode current collector, and thus, it becomes very difficult for the fibrous carbon material to form conductive paths. Due to the above-described reasons, conductive paths are not easily formed even when the thickness of the high resistance-increase layer is very small, and therefore, high energy density can be achieved without impairing the effect of the high tolerance to overcharging of the positive electrode with a multi-layered structure.

### BRIEF DESCRIPTION OF THE DRAWINGS

FIG. 1 is a schematic diagram for illustrating a heat transfer passage in a conventional positive electrode;

FIG. 2 is a schematic diagram for illustrating a heat transfer passage in the present invention;

FIG. 3 is a schematic diagram for illustrating a power-generating element of the present invention;

FIG. 4 is a graph illustrating battery voltage, battery current, and battery temperature, versus charging time of a Battery A1 of the present invention;

FIG. 5 is a graph illustrating battery voltage, battery current, and battery temperature, versus charging time of Conventional Battery X1 of the present invention;

FIG. 6 is a graph showing a portion of FIG. 5 enlarged, in which the charge time is from 30 minutes to 40 minutes;

FIG. 7 is a schematic view illustrating the state of the positive electrode in Comparative Battery X1; and

FIG. 8 is a schematic view illustrating the state of the positive electrode in Battery A1 of the present invention.

### DETAILED DESCRIPTION OF THE INVENTION

Here, for the purpose of illustration, a constitutional element of the invention “the positive electrode active material-layer stack . . . comprising a plurality of layers respectively having a plurality of different positive electrode active materials, wherein, among the plurality of layers, at least one layer other than the outermost positive electrode layer contains as its main active material a positive electrode active material having the highest resistance increase rate during overcharging” will be described in more detail in comparison with the technique disclosed in JP 2001-338639A (hereinafter simply referred to as the “conventional technique”), which is described above in the “Background of the Invention.” It should be noted that, among the constitutional elements of the invention, a constitutional element “the at least one layer containing as its main active material the positive electrode active material having the highest resistance increase rate contains a fibrous carbon material as a conductivity enhancing agent” is not mentioned in the publication of the conventional technique.

(1) Difference in Reaction Modes Between the Conventional Technique and the Present Invention

The conventional technique employs, so to speak, a static test, in which heat generation of a battery is caused by simply sticking a nail into the battery without accompanying a charge reaction. In contrast, the present invention adopts, so to speak, a dynamic test, in which heat generation of a battery is caused by actually charging the battery. Specifically, the differences are as follows.

(I) Although both techniques deal with the problem of thermal runaway caused by heat generation of a battery, the conventional technique does not take a charge-discharge reaction into consideration, so the reaction takes place relatively uniformly in locations other than the location where the nail is stuck. On the other hand, in the present invention, a decomposition reaction of the electrolyte solution occurs due to the actual charging operation, which accompanies a gas formation. Therefore, the electrode reaction (charge reaction) becomes non-uniform, creating variations in the reaction from one location to another in the electrodes.

(II) The conventional technique is free from the problem of deposited lithium, so it is only necessary to take the thermal stability of the positive electrode into consideration. In contrast, since the present invention involves a charge reaction, the problem of dendrite due to the deposited lithium arises.

(III) Since the conventional technique does not involve a charge reaction, the thermal stability of the active material does not change over time. In contrast, because the present invention involves a charge reaction, the thermal stability of the active material varies greatly depending on the charge depth. Specifically, the greater the charge depth is, the lower the stability of the active material.

As discussed in the foregoing (I) and (II), the reaction modes greatly differ between the conventional technique and the present invention, and therefore, it is obvious that a battery design that is effective in the nail penetration test is not necessarily also effective in the overcharging test. Moreover, concerning the issue of thermal stability of active material as discussed in the foregoing (III) as well, the operations and advantageous effects will not be the same since there are differences in static or dynamic concepts between the conventional technique and the present invention.

(2) Difference in Thermal Transfer Passage Between the Conventional Technique and the Present Invention

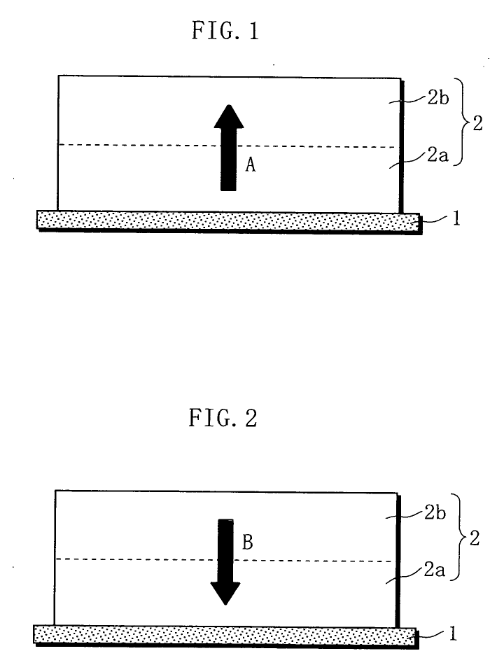

In the conventional technique, as described in the specification, generated heat spreads over the entire battery through the nail and the positive electrode current collector, which have high thermal conductivities and thus serve as heat conductors. That is, as illustrated in FIG. 1, the heat transfers from a lower layer 2a toward an upper layer 2b (in the direction indicated by the arrow A) in a positive electrode active material 2. For this reason, the conventional technique employs a construction in which a material having a higher thermal stability is arranged in the lower layer. On the other hand, in the present invention, what causes a reaction initially when overcharged is lithium deposited on the negative electrode surface. Therefore, as illustrated in FIG. 2, heat transfers from the upper layer 2b toward the lower layer 2a (in the direction indicated by the arrow B) in the positive electrode active material 2. In FIGS. 1 and 2, reference numeral 1 denotes a positive electrode current collector.

(3) Characteristic Features of the Present Invention Based on the Differences Discussed Above

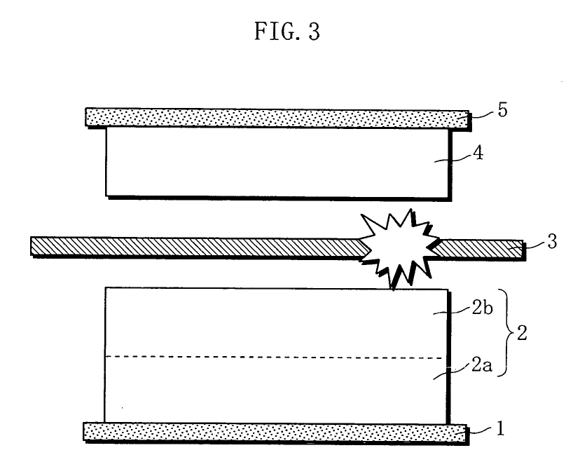

When considering a battery construction that can improve tolerance of a battery to overcharging based on the above-described differences, it is effective to employ a construction in which, as illustrated in FIG. 3, a layer that is other than the outermost positive electrode layer (i.e., the lower layer 2a in FIG. 3) comprises, among the different positive electrode active materials, the positive electrode active material that has the highest resistance increase rate during overcharge. (In FIG. 3, the parts having the same functions as those in FIGS. 1 and 2 are designated by the same reference characters.) With the above-described construction, the current collection performance of the upper layer 2b lowers, reducing the amount of lithium deposited on the negative electrode 4, and the charge depth of the active material in the upper layer 2b lessens. As a consequence, the thermal runaway reaction does not occur easily. Thus, it is possible to reduce the total amount of heat produced within the battery and to prevent the thermal stability of the active material at the surface from degrading.

Thus, the improvement in the positive electrode structure in the above-described manner makes it possible to prevent the deposition of lithium and reduce the total amount of heat produced in the battery. As a result, the tolerance of the battery to overcharging can be improved remarkably.

It is preferable that the at least one layer containing as its main active material the positive electrode active material having the highest resistance increase rate be a layer in contact with the positive electrode current collector.

When, as in the foregoing construction, the layer in contact with the current collector contains the positive electrode active material having the highest resistance increase rate among the positive electrode active materials, all the layers other than the layer in contact with the current collector have lower current collection performance than that of the layer in contact with the current collector; therefore, the advantageous effects of the present invention are exhibited more effectively.

It is preferable that the layer in contact with the current collector have a thickness of 5 μm or less.

With this construction, the thickness of the positive electrode active material that has a large discharge capacity per unit mass can consequently be made large, and the amount of that positive electrode active material can be increased accordingly. Therefore, the energy density of the battery can be improved remarkably.

It is preferable that the positive electrode active material of the at least one layer containing as its main active material the positive electrode active material having the highest resistance increase rate comprise an olivine-type lithium phosphate compound represented by the general formula LiMPO₄, where M is at least one element selected from the group consisting of Fe, Ni, and Mn.

Although possible examples of the main positive electrode active material in the layer containing the positive electrode active material having the highest resistance increase rate during overcharge may include an olivine-type lithium phosphate compound and spinel-type lithium manganese oxide, the olivine-type lithium phosphate compound shows a greater increase in the direct current resistance than the spinel-type lithium manganese oxide at the time when lithium ions are extracted from the interior of the crystals. It is believed that this is dependent on the crystal structure of the positive electrode active material.

More specifically, it is believed that the spinel-type lithium manganese oxide shows a smaller increase rate in the direct current resistance because it has some oxygen defects in the spinel structure, through which electrons can flow. In contrast, it is believed that the olivine-type lithium phosphate compound has almost no such defects and therefore shows a greater increase rate in resistance.

Moreover, since the olivine-type lithium phosphate compound exhibits a lower potential than the spinel-type lithium manganese oxide at the time when almost all the lithium ions have been extracted from the interior of the crystals, the above-described advantageous effects emerge before the charge depth reaches to a depth at which the lithium cobalt oxide etc. that is nearer the surface of the positive electrode starts to degrade in terms of safety. Thus, the use of the olivine-type lithium phosphate compound as the main positive electrode active material in the high resistance-increase layer allows the advantageous effects of the present invention to be exhibited more effectively.

It is preferable that a layer nearer an electrode surface than is the at least one layer containing the positive electrode active material having the highest resistance increase rate as its main active material contains lithium cobalt oxide as a positive electrode active material.

Lithium cobalt oxide has a large capacity per unit volume. Therefore, when lithium cobalt oxide is contained as a positive electrode active material as in the foregoing construction, the capacity of the battery can be increased.

It is preferable that the total mass of the lithium cobalt oxide be greater than the total mass of the olivine-type lithium phosphate compound.

When, as in the foregoing construction, the total mass of the lithium cobalt oxide is controlled to be greater than the total mass of the olivine-type lithium manganese oxide, the energy density of the battery as a whole can be increased because the lithium cobalt oxide has a greater specific capacity than that of the olivine-type lithium manganese oxide.

It is preferable that the lithium cobalt oxide be present in the outermost positive electrode layer.

When the lithium cobalt oxide is present in the outermost positive electrode layer, the current collection performance of the lithium cobalt oxide lowers further and the lithium cobalt oxide is inhibited from being charged to the charge depth that should reach otherwise. Thus, the amount of lithium deintercalated from the lithium cobalt oxide, which contains a large amount of lithium even in the overcharge region, decreases considerably, and accordingly the amount of heat produced from the reaction between the electrolyte solution and the lithium deposited on the negative electrode reduces remarkably. Moreover, thermal stability of the lithium cobalt oxide is also kept relatively high.

It is preferable that the non-aqueous electrolyte battery of the invention further have a battery case for accommodating a power-generating element containing the positive and negative electrodes and the separator, the battery case being flexible.

In addition to the function to increase the resistance because of the extraction of lithium ions from the interior of the crystals during charging as discussed above, the olivine-type lithium phosphate compound shows weaker capability of decomposing the electrolyte solution in the oxidation state than both the spinel-type lithium manganese oxide and lithium cobalt oxide. It also produces a less amount of gas originating from the decomposition of the electrolyte solution in the overcharged state. For this reason, the use of the olivine-type lithium phosphate compound as a positive electrode active material can also prevent the problem of short circuiting within the battery even when a flexible battery case is used, because the problem of swelling of the battery does not easily occur. An example of the battery case that is flexible includes, but is not limited to, an aluminum laminate battery case.

Thus, the present invention achieves the advantageous effect of the improvement in battery safety, particularly the improvement in the tolerance of a battery to overcharging, while preventing the discharge capacity from degrading.

### EMBODIMENT

Hereinbelow, the present invention is described in further detail based on preferred embodiments thereof. It should be construed, however, that the present invention is not limited to the following preferred embodiments but various changes and modifications are possible without departing from the scope of the invention.

Preparation of Positive Electrode

First, an olivine-type lithium iron phosphate LiFePO₄ (hereinafter also abbreviated as “LFP”) serving as a positive electrode active material was mixed with VGCF (vapor growth carbon fiber, made by Showa Denko Kabushiki Kaisha) and acetylene black as conductivity enhancing agents at a mass ratio of 92:5:3 to prepare a positive electrode mixture powder. It should be noted that 5% of carbon as a conductive agent was added to the above-described olivine-type lithium iron phosphate compound at the time of baking. The olivine-type lithium phosphate compound is poor in electrical conductivity and shows inferior load characteristics. By providing conductive paths by the carbon inside the secondary particle at the stage of baking of the positive electrode active material, good battery performance can be ensured. It also should be noted that in the present specification, the term “conductive agent” means the electrically conductive component contained within the positive electrode active material particle, and the term “conductivity enhancing agent” means the electrically conductive component contained between the positive electrode active material particles.

Next, 200 g of the resultant powder was put into a mixer (for example, a mechanofusion system AM-15F made by Hosokawa Micron Corp.), and the mixer was operated at a rate of 1500 rpm for 10 minutes to cause compression, shock, and shear actions while mixing, to thus prepare a positive electrode active material mixture. Subsequently, the resultant positive electrode active material mixture and a fluoropolymer-based binder agent (PVDF) were mixed at a mass ratio of 97:3 in an N-methyl-2-pyrrolidone (NMP) solvent to prepare a positive electrode slurry. Thereafter, the positive electrode slurry was applied onto both sides of an aluminum foil serving as a positive electrode current collector, and the resultant material was then dried and pressure-rolled. Thus, a first positive electrode active material layer was formed on a surface of the positive electrode current collector.

Subsequently, another positive electrode slurry was prepared in the same manner as in the foregoing, except that lithium cobalt oxide (hereinafter also abbreviated as “LCO”) was used as the positive electrode active material and particulate SP300 (made by Nippon Graphite Industries) and particulate acetylene black were used as the carbon conductivity enhancing agents. Further, the resultant positive electrode slurry was applied on top of the first positive electrode active material layer, and the resultant material was then dried and pressure-rolled. Thus, a second positive electrode active material layer was formed on the surface of the positive electrode current collector.

The positive electrode was prepared in the above-described manner. The mass ratio of the two positive electrode active materials LCO and LFP was LCO:LFP=96:4 in the positive electrode.

Preparation of Negative Electrode

A carbon material (graphite), CMC (carboxymethylcellulose sodium), and SBR (styrene-butadiene rubber) were mixed in an aqueous solution at a mass ratio of 98:1:1 to prepare a negative electrode slurry. Thereafter, the negative electrode slurry was applied onto both sides of a copper foil serving as a negative electrode current collector, and the resultant material was then dried and rolled. Thus, a negative electrode was prepared.

Preparation of Non-aqueous Electrolyte Solution

A lithium salt composed mainly of LiPF₆ was dissolved at a concentration of 1.0 mole/L in a mixed solvent of 3:7 volume ratio of ethylene carbonate (EC) and diethyl carbonate (DEC) to prepare a non-aqueous electrolyte solution.

Construction of Battery

Lead terminals were attached to the positive and negative electrodes, and the positive and negative electrodes were wound in a spiral form with a polyethylene separator interposed therebetween. The wound electrodes were then pressed into a flat shape to obtain a power-generating element, and thereafter, the power-generating element was accommodated into an enclosing space made by an aluminum laminate film serving as a battery case. Then, the non-aqueous electrolyte solution was filled into the space, and thereafter the battery case was sealed by welding the aluminum laminate film, to thus prepare a battery.

The above-described battery had a design capacity of 780 mAh.

### EXAMPLES

### Example 1

A battery fabricated in the same manner as described in the foregoing embodiment was used as Example 1.

The battery fabricated in this manner is hereinafter referred to as Battery A1 of the invention.

### Example 2

A battery was fabricated in the same manner as in Example 1 above, except that the mass ratio of the positive electrode active materials LCO and LFP in the positive electrode was set to be LCO:LFP=71:29.

The battery fabricated in this manner is hereinafter referred to as Battery A2 of the invention.

### Comparative Example 1

A battery was fabricated in the same manner as in Example 1 above, except that a particulate conductivity enhancing agent (SP300 mentioned above) was used as the conductivity enhancing agent of the first positive electrode active material layer.

The battery fabricated in this manner is hereinafter referred to as Comparative Battery X1 of the invention.

### Comparative Example 2

A battery was fabricated in the same manner as in Example 2 above, except that a particulate conductivity enhancing agent (SP300 mentioned above) was used as the conductivity enhancing agent of the first positive electrode active material layer.

The battery fabricated in this manner is hereinafter referred to as Comparative Battery X2 of the invention.

### Comparative Example 3

A battery was fabricated in the same manner as in Comparative Example 1 above, except that a single layer structure was adopted for the positive electrode active material-layer stack, instead of the double layer structure (a mixture of LCO and LMO was used as the positive electrode active material).

The battery fabricated in this manner is hereinafter referred to as Comparative Battery X3 of the invention.

### Comparative Example 4

A battery was fabricated in the same manner as in Comparative Example 2 above, except that a single layer structure was adopted for the positive electrode active material-layer stack, instead of the double layer structure (a mixture of LCO and LMO was used as the positive electrode active material).

The battery fabricated in this manner is hereinafter referred to as Comparative Battery X4 of the invention.

### Comparative Example 5

A battery was fabricated in the same manner as in Comparative Example 3 above, except that a fibrous conductivity enhancing agent (VGCF mentioned above) was used as the conductivity enhancing agent.

The battery fabricated in this manner is hereinafter referred to as Comparative Battery X5 of the invention.

Experiment

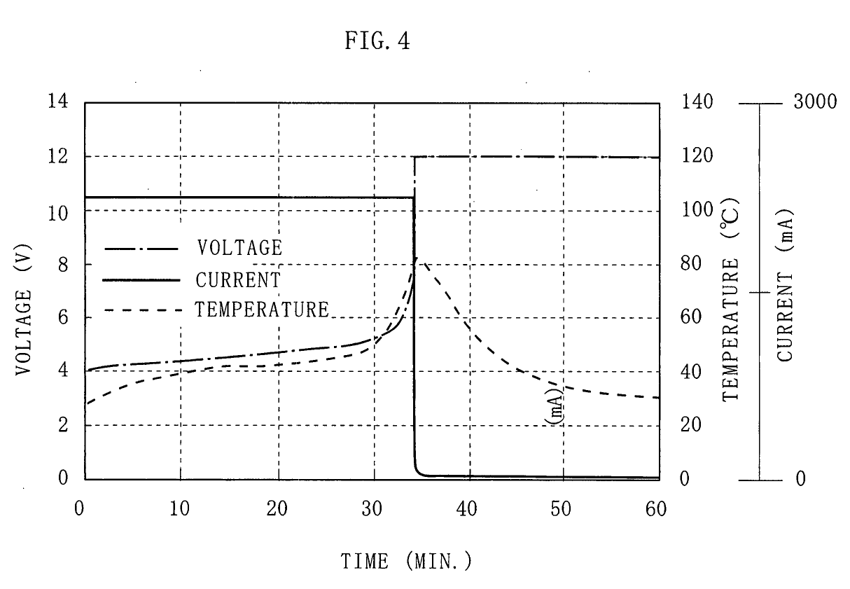

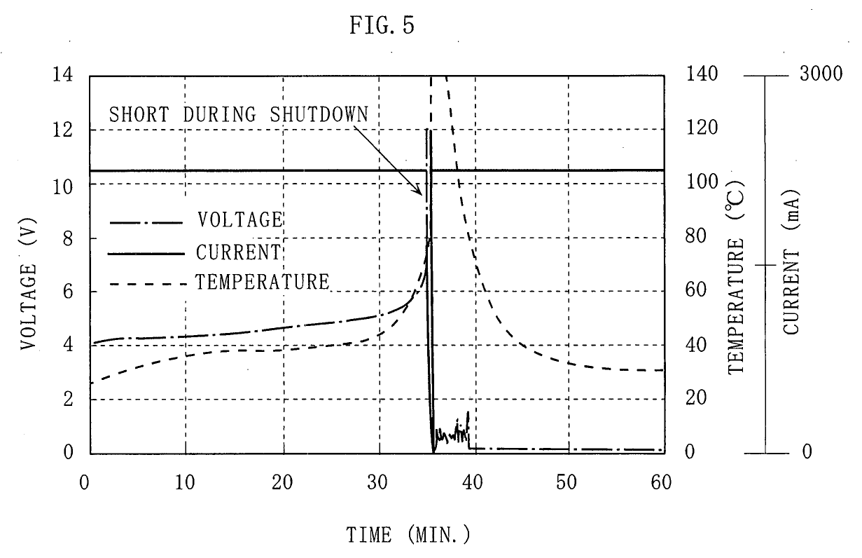

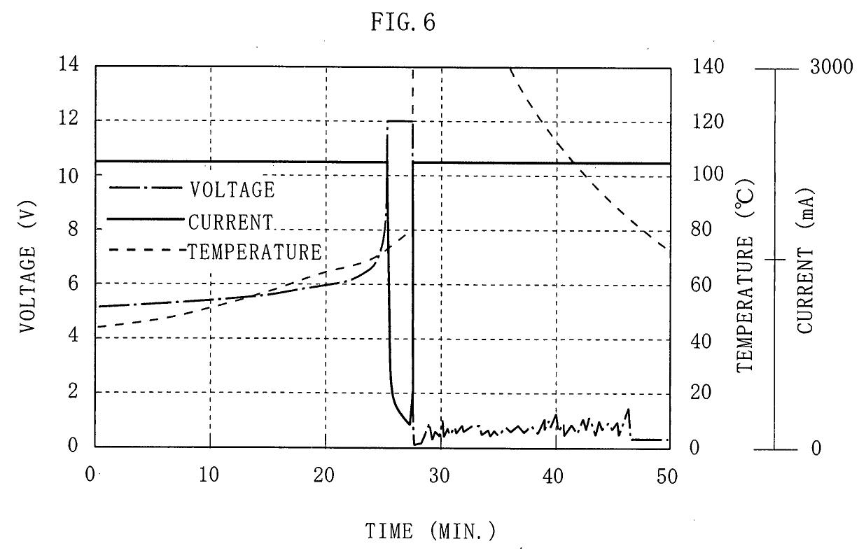

Batteries A1 and A2 as well as Comparative Batteries X1 to X5 were studied for the tolerance of the battery to overcharging. The results are shown in Table 1 below. The conditions of the experiment were as follows. Samples of the batteries were subjected to a charge test using circuits that charge the batteries, with a current of 750 mA being defined as 1.0 It, at currents of 1.0 It, 2.0 It, and 3.0 It until the battery voltages reached 12 V, and then the batteries were charged at a constant voltage (with no lower current limit). After a voltage of 12 V was reached, the charging was continued for 3 hours. With Battery A1 of the invention and Comparative Battery X1, the relationships of current, voltage, and temperature versus charge time were determined by overcharging the batteries at a current of 3.0 It (2250 mA). The results are shown in FIGS. 4 and 5, respectively. FIG. 6 shows a portion of FIG. 5 enlarged, in which the charge time is from 30 minutes to 40 minutes.

Usually, a battery (battery pack) is provided with a protection circuit or a protective device such as a PTC device so that the safety of the battery in abnormal conditions can be ensured. In a unit cell as well, various safety mechanisms are adopted such as a separator shutdown (SD) function (the function to insulate the positive and negative electrodes from each other by heat-clogging pores in a microporous film) and additives to the electrolyte solution so that the safety can be ensured even without the protection circuit and the like. In the present experiment, however, such materials and mechanisms for improving the safety were eliminated except for the separator shutdown function in order to prove the superiority in safety of the batteries of the invention, and the behaviors of the batteries during overcharge were studied.

TABLE 1

| | | Positive electrode | | | | | | | |
|---|---|---|---|---|---|---|---|---|---|
| | | active material | | | Type of conductive agent | | | | |
| | | | First positive | | | First positive | | | |
| | | Second positive | electrode active | | Second positive | electrode active | Number of batteries with short circuit | | |
| | Positive | electrode active | material layer | LCO:LFP | electrode active | material layer | Type of SD (shutdown) | | |
| | electrode | material layer | (current collector | (Mass | material layer | (current | 1.0It | 2.0It | |
| Battery | structure | (surface side) | side) | ratio | (surface side) | collector side) | overcharge | overcharge | 3.0It overcharge |
| A1 | Double | LCO | LFP | 96:4 | Particle | Fibrous | No | No | No |
| | layer | | | | (SP300) | (VGCF) | Electrode SD | Electrode SD | Electrode SD |
| A2 | Double | LCO | LFP | 71:29 | Particle | Fibrous | No | No | No |
| | layer | | | | (SP300) | (VGCF) | Electrode SD | Electrode SD | Electrode SD |
| X1 | Double | LCO | LFP | 96:4 | Particle | Particle | 3/3 | 3/3 | 3/3 |
| | layer | | | | (SP300) | (SP300) | Short | Short | Short during SD |
| | | | | | | | during SD | during SD | |
| X2 | Double | LCO | LFP | 71:29 | Particle | Particle | No | No | No |
| | layer | | | | (SP300) | (SP300) | Electrode SD | Electrode SD | Electrode SD |

| X3 | Single | LCO/LFP mixture | 96:4 | Particle | 3/3 | 3/3 | 3/3 |
|---|---|---|---|---|---|---|---|
| | layer | | | (SP300) | No | No | No electrode SD |
| | | | | | electrode SD | electrode SD | |
| X4 | Single | LCO/LFP mixture | 71:29 | Particle | No | 3/3 | 3/3 |
| | layer | | | (SP300) | Separator SD | No | No electrode SD |
| | | | | | | electrode SD | |
| X5 | Single | LCO/LFP mixture | 96:4 | Fibrous | 3/3 | 3/3 | 3/3 |
| | layer | | | (VGCF) | No | No | No electrode SD |
| | | | | | electrode SD | electrode SD | |
| In Table 1, the samples were determined whether the shutdown (SD) was originated from the separator or from the electrode, based on visual observation of swelling of the battery and change of separator's air permeability after overcharge. Specifically, the air permeability of the separator greatly changes when the separator-originated SD works. Accordingly, it was determined that the | | | | | | | |
| # separator-originated SD worked when the air permeability greatly changed; on the other hand, it was determined that the electrode-originated SD (the SD due to the resistance increase of the electrode) worked when the air permeability greatly did not change much. | | | | | | | |

The phrase “Short during SD” means that a short circuit occurred during the electrode-originated SD.
The cell indicated as “No electrode SD” and showing short circuits (e.g., Comparative Battery X4 overcharged at 2.0 It) means that the samples of the battery caused short circuits during the separator-originated SD.

Results of the Experiment

As clearly seen from Table 1 above, in each of Batteries A1 and A2 of the invention as well as Comparative Batteries X1 and X2, which have the positive electrodes with a double layer structure, the current collection performance of the LCO in the second positive electrode active material layer is lowered in the overcharge region because the resistance of the LFP of the first positive electrode active material layer increases. For this reason, the charging of LCO becomes difficult to proceed, and this allows the SD function of the positive electrode to be exerted.

Here, in the cases that the amount of LFP was relatively large, the positive electrode-originated SD function was exhibited smoothly regardless of whether the conductivity enhancing agent used for the first positive electrode active material layer was in particulate form or in fibrous form (cf. Battery A2 of the invention and Comparative Battery X2). On the other hand, in the cases that the amount of LFP was small, although Comparative Battery X1, in which the conductivity enhancing agent used for the first positive electrode active material layer was in particulate form, resulted in a sudden short circuit during the time in which electric current was being shut off (cf. FIGS. 5 and 6), Battery A1 of the invention, in which the conductivity enhancing agent used for the first positive electrode active material layer was in fibrous form, showed no short circuit and exhibited high resistance to overcharging (cf. FIG. 4).

In addition, in Comparative Batteries X3 to X5, which had positive electrodes with a single layer structure, no electrode-originated SD behavior occurred and moreover short circuits occurred in nearly all the samples, regardless of the amount of LFP and the form of the conductivity enhancing agent.

Analysis of the Results of the Experiment

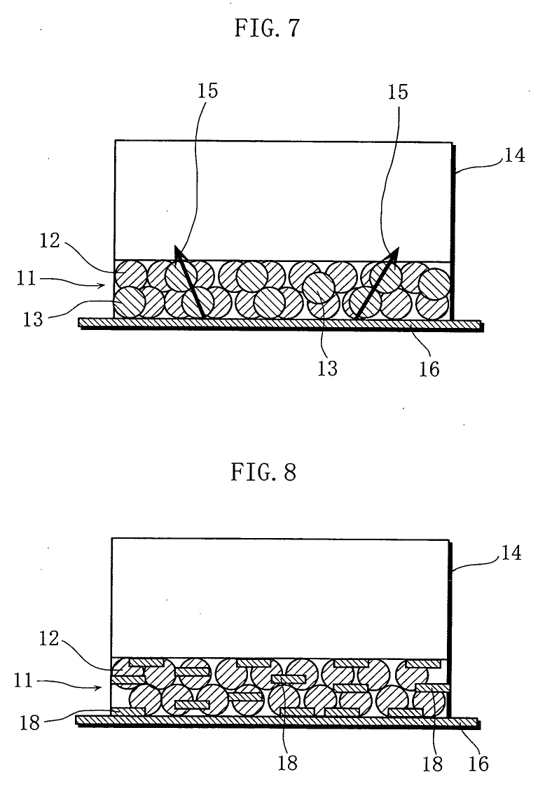

The reasons why the above-described results of the experiment were observed will be explained with reference to FIGS. 7 and 8. FIG. 7 is a schematic view illustrating the state of the positive electrode in Comparative Battery X1, and FIG. 8 is a schematic view illustrating the state of the positive electrode in Battery A1 of the invention. In each of the figures, reference numeral 11 denotes the first positive electrode active material layer. Reference numeral 12 denotes the positive electrode active material. Reference numeral 13 denotes the particulate conductivity enhancing agent. Reference numeral 14 denotes the second positive electrode active material layer. Reference numeral 15 denotes conductive paths. Reference numeral 16 denotes the positive electrode current collector. Reference numeral 18 denotes the fibrous conductivity enhancing agent.

In the cases of Comparative Battery X2 (which uses SP300 [average particle size: about 5 μm to 50 μm] and acetylene black [average particle size: about 35 nm] as the conductivity enhancing agents) and Battery A2 of the invention (which uses VGCF [average fiber diameter: 150 nm, fiber length: 9 μm] and acetylene black [average particle size: about 35 nm] as the conductivity enhancing agents), the mass ratio of LCO to LFP is 71:29, and the amount of LFP is relatively large. Accordingly, the first positive electrode active material layer containing LFP as the positive electrode active material has a relatively large thickness (the thickness of one side of the first positive electrode active material layer is about 16 μm). This allows the conductivity enhancing agent and the positive electrode active material to be dispersed to an appropriate degree, and therefore prevents the conductivity enhancing agent of the first positive electrode active material layer from forming such conductive paths that direct electrical conduction is established therethrough between the positive electrode current collector and the second positive electrode active material layer.

On the other hand, in the case of Comparative Battery X1 (which uses SP300 and acetylene black as the conductivity enhancing agents, as with Comparative Battery X2), the mass ratio of LCO to LFP is 96:4, so the amount of LFP is small. Accordingly, the first positive electrode active material layer, which uses LFP as the positive electrode active material, is very thin (the thickness of one side of the first positive electrode active material layer is about 4 μm). Consequently, as shown in FIG. 8, conductive paths 15 are formed by the conductivity enhancing agent SP300 alone, such that electrical conduction is established between the positive electrode current collector and the second positive electrode active material layer. As a result, even when the resistance of the first positive electrode active material layer is increased during overcharge, the regions with low resistance are left in spots because of the conductive paths 15. The LCO active material in contact with those spots is overcharged, and a large current tends to easily pass through the spots. Therefore, violent heat generation occurs at those locations, causing short circuits through the separator, as shown in FIGS. 5 and 6.

In contrast, in the case of Battery A1 of the invention (which uses VGCF and acetylene black as the conductivity enhancing agents, as with Battery A2 of the invention), VGCF has an excellent capability as a conductivity enhancing agent because VGCF has, by nature, better dispersion capability and higher conductivity than such materials as SP300 and acetylene black. Moreover, VGCF has a very small fiber diameter, as previously mentioned, so the use of VGCF alone can prevent the formation of the conductive paths even when the thickness of one side of the first positive electrode active material layer is set at about 4 μm as in the foregoing. This is because, when preparing the positive electrode, a compressing process is necessarily carried out after coating the slurry, in order to enhance the filling density of the positive electrode active material, and as a consequence, the carbon fibers are oriented substantially in a direction parallel to the positive electrode current collector 16 by the compressing process, as shown in FIG. 8.

Conclusion

As has been discussed above, the use of a fibrous material (such as VGCF) as a conductivity enhancing agent prevents the formation of the conductive paths formed by the conductivity enhancing agent alone even when the first positive electrode active material layer is very thin, and it does not impair the improvement effect in overcharge resistance obtained by adopting a double layer structure for the positive electrode.

Moreover, the VGCF has very good dispersion capability. Also, the use of VGCF allows the first positive electrode active material layer to be very thin, so the amount of the second positive electrode active material layer's positive electrode active material (LCO), which has a high energy density, becomes relatively large. Therefore, a higher energy density of the battery is achieved.

Additional Advantage of Batteries of the Invention

Although not specifically mentioned in the foregoing experiment, it was confirmed that Batteries A1 and A2 of the invention showed little swelling of the battery that results from the decomposition of the electrolyte solution. It is believed that the reason is as follows. Because of SD, the charge depth of LCO does not change greatly in the second positive electrode active material layer. Therefore, the oxidizability of the positive electrode to the electrolyte solution does not become high, and the resistance increase of the electrode occurs at an early stage. Consequently, the temperature of the battery does not become very high.

Other Embodiments

(1) The fibrous conductivity enhancing agent is not limited to VGCF, and various types of fibrous conductivity enhancing agents may be used as long as the fiber diameter is small. It should be noted that the fiber diameter of VGCF is not limited to 150 nm mentioned in the foregoing embodiment. Nevertheless, the advantageous effects of the present invention cannot be fully attained if the fiber diameter is excessively large. Therefore, it is desirable that the fiber diameter be controlled to be 500 nm or less.

In addition, the amount of VGCF with respect to the total amount of the positive electrode mixture powder is not limited to 5 mass % as mentioned in the foregoing embodiment. However, if the amount of VGCF is excessively large, such problems arise that the effect of the resistance increase in the first positive electrode active material layer is lessened and that the increase in the capacity of the positive electrode is impaired. For this reason, it is preferable that the amount of VGCF is controlled to be 10 mass % or less, and more preferably 5 mass % or less, with respect to the total amount of the positive electrode mixture powder.

(2) The positive electrode active materials are not limited to lithium cobalt oxide and the olivine-type lithium phosphate compound. Other usable materials include spinel-type lithium manganese oxides, lithium nickel oxide, and layered lithium-nickel compounds. Table 2 below shows the resistance increase rates during overcharge, the amounts of lithium extracted in overcharging, and the amounts of remaining lithium in a charged state to 4.2 V, for the positive electrode active materials made of these substances. Herein, it is necessary to use the one having a high resistance increase rate during overcharge for the first positive electrode active material layer (the layer nearer the positive electrode current collector) with reference to Table 2.

TABLE 2

| | Resistance | Amount of lithium | Amount of |
|---|---|---|---|
| | increase during | that can be extracted | remaining lithium in |
| Type of positive electrode | overcharge | in overcharging | 4.2 V charged state |
| active material | (4.2 V reference) | (4.2 V reference) | (%) |
| Lithium cobalt oxide | Small (Slow) | Very large | 40 |
| (LiCoO₂) | | | |
| Spinel-type lithium | Large (Fast) | Small | Almost non-existent |
| manganese oxide | | | |
| (LiMn₂O₄) | | | |
| Lithium nickel oxide | Fair | Large | 20-30 |
| (LiNiO₂) | | | |
| Olivine-type lithium ion | Very large | Small | Almost non-existent |
| phosphate | (Very Fast) | | |
| (LiFePO₄) | | | |
| Layered lithium-nickel | Fair | Large | 20-30 |
| compound | | | |
| (LiNi_{1/3}Mn_{1/3}Co_{1/3}O₂) | | | |

The olivine-type lithium phosphate compound is not limited to LiFePO₄. Specifically, the details are as follows.

The olivine-type lithium phosphate compounds represented by the general formula LiMPO₄ show various working voltage ranges depending on the type of the element M. It is well known that LiFePO₄ results in a plateau from 3.3 V to 3.5 V in the 4.2 V region, in which commercial lithium-ion batteries are generally used, and it deintercalates most of the Li ions from the crystals with the charge at 4.2 V. In the case where the element M is a Ni—Mn-based mixture, the plateau emerges from 4.0 V to 4.1 V, and the compound deintercalates most of the Li ions from the crystals with the charge at 4.2 V to 4.3 V. In order to achieve the advantageous effects of the invention with existing lithium ion batteries, it is necessary that the olivine-type lithium phosphate compound exhibit its advantageous effects quickly while preventing the positive electrode capacity from degrading by contributing to charging and discharging during normal charge-discharge reactions to a certain extent, and that it have a discharge working voltage similar to those of LCO and Li—NiMnCo oxide compounds so that the battery discharge curve will not result in a multi-staged shape. In that sense, it is desirable to use an olivine lithium oxide compound in which the element M contains at least one element selected from Fe, Ni, and Mn, and that has a discharge working potential of from about 3.0 V to about 4.0 V.

(3) Although the foregoing examples use an olivine-type lithium phosphate compound alone as the active material of the first positive electrode active material layer, this construction is merely illustrative of the invention. It is of course possible to use, for example, a spinel-type lithium manganese oxide alone, or a mixture of a spinel-type lithium manganese oxide and an olivine-type lithium iron phosphate, as the active material of the first positive electrode active material layer. Likewise, it is possible to use a mixture material for the second positive electrode active material layer.

(4) The positive electrode structure is not limited to the two-layer structure, and a structure comprising three or more layers may of course be employed. For example, in the case of the three-layer structure, an active material having a large resistance increase rate should be used for the lower layer (the layer adjacent to the positive electrode current collector) or for an intermediate layer. In order to improve the tolerance of the battery to overcharging remarkably, it is desirable that an active material having a large resistance increase rate should be used for the lower layer.

(5) The method for mixing the positive electrode mixture is not limited to the above-noted mechanofusion method. Other possible methods include a method in which the mixture is dry-blended while milling it with a Raikai-mortar, and a method in which the mixture is wet-mixed and dispersed directly in a slurry.

(6) The negative electrode active material is not limited to graphite described above. Various other materials may be employed, such as coke, tin oxides, metallic lithium, silicon, and mixtures thereof, as long as the material is capable of intercalating and deintercalating lithium ions.

(7) The lithium salt in the electrolyte solution is not limited to LiPF₆, and various other substances may be used, including LiBF₄, LiN(SO₂CF₃)₂, LiN(SO₂C₂F₅)₂, LiPF₆₋ₓ(CₙF₂ₙ₊₁)ₓ (wherein 1<x<6 and n=1or 2), which may be used either alone or in combination of two or more of them. The concentration of the lithium salt is not particularly limited, but it is preferable that the concentration of the lithium salt be restricted in the range of from 0.8 moles to 1.5 moles per 1 liter of the electrolyte solution. The solvents for the electrolyte solution are not particularly limited to ethylene carbonate (EC) and diethyl carbonate (DEC) mentioned above, and preferable solvents include carbonate solvents such as propylene carbonate (PC), γ-butyrolactone (GBL), ethyl methyl carbonate (EMC), and dimethyl carbonate (DMC). More preferable is a combination of a cyclic carbonate and a chain carbonate.

(8) The present invention may be applied to gelled polymer batteries as well as liquid-type batteries. In this case, usable examples of the polymer material include polyether-based solid polymer, polycarbonate solid polymer, polyacrylonitrile-based solid polymer, oxetane-based polymer, epoxy-based polymer, and copolymers or cross-linked polymers comprising two or more of these polymers, as well as PVDF. Any of the above examples of polymer material may be used in combination with a lithium salt and an electrolyte to form a gelled solid electrolyte.

The present invention is applicable not only to driving power sources for mobile information terminals such as mobile phones, notebook computers and PDAs but also to large-sized batteries for, for example, in-vehicle power sources for electric automobiles or hybrid automobiles.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

What is claimed is:

1. A non-aqueous electrolyte battery comprising:
a positive electrode including a positive electrode active material-layer stack and a positive electrode current collector, the positive electrode active material-layer stack being formed on a surface of the positive electrode current collector and comprising a plurality of layers respectively having a plurality of different positive electrode active materials, wherein, among the plurality of layers, at least one layer other than the outermost positive electrode layer contains as its main active material a positive electrode active material having the highest resistance increase rate during overcharge among the positive electrode active materials, and the at least one layer containing as its main active material the positive electrode active material having the highest resistance increase rate contains a fibrous carbon material as a conductivity enhancing agent;
a negative electrode including a negative electrode active material layer; and
a separator interposed between the electrodes.

2. The non-aqueous electrolyte battery according to claim 1, wherein the at least one layer containing as its main active material the positive electrode active material having the highest resistance increase rate is a layer in contact with the positive electrode current collector.

3. The non-aqueous electrolyte battery according to claim 2, wherein the layer in contact with the positive electrode current collector has a thickness of 5 μm or less.

4. The non-aqueous electrolyte battery according to claim 1, wherein the positive electrode active material of the at least one layer containing as its main active material the positive electrode active material having the highest resistance increase rate comprises an olivine-type lithium phosphate compound represented by the general formula LiMPO₄, where M is at least one element selected from the group consisting of Fe, Ni, and Mn.

5. The non-aqueous electrolyte battery according to claim 2, wherein the positive electrode active material of the at least one layer containing as its main active material the positive electrode active material having the highest resistance increase rate comprises an olivine-type lithium phosphate compound represented by the general formula LiMPO₄, where M is at least one element selected from the group consisting of Fe, Ni, and Mn.

6. The non-aqueous electrolyte battery according to claim 3, wherein the positive electrode active material of the at least one layer containing as its main active material the positive electrode active material having the highest resistance increase rate comprises an olivine-type lithium phosphate compound represented by the general formula LiMPO₄, where M is at least one element selected from the group consisting of Fe, Ni, and Mn.

7. The non-aqueous electrolyte battery according to claim 1, wherein a layer nearer an electrode surface than is the at least one layer containing as its main active material the positive electrode active material having the highest resistance increase rate contains lithium cobalt oxide as a positive electrode active material.

8. The non-aqueous electrolyte battery according to claim 2, wherein a layer nearer an electrode surface than is the at least one layer containing as its main active material the positive electrode active material having the highest resistance increase rate contains lithium cobalt oxide as a positive electrode active material.

9. The non-aqueous electrolyte battery according to claim 3, wherein a layer nearer an electrode surface than is the at least one layer containing as its main active material the positive electrode active material having the highest resistance increase rate contains lithium cobalt oxide as a positive electrode active material.

10. The non-aqueous electrolyte battery according to claim 4, wherein a layer nearer an electrode surface than is the at least one layer containing as its main active material the positive electrode active material having the highest resistance increase rate contains lithium cobalt oxide as a positive electrode active material.

11. The non-aqueous electrolyte battery according to claim 5, wherein a layer nearer an electrode surface than is the at least one layer containing as its main active material the positive electrode active material having the highest resistance increase rate contains lithium cobalt oxide as a positive electrode active material.

12. The non-aqueous electrolyte battery according to claim 6, wherein a layer nearer an electrode surface than is the at least one layer containing as its main active material the positive electrode active material having the highest resistance increase rate contains lithium cobalt oxide as a positive electrode active material.

13. The non-aqueous electrolyte battery according to claim 10, wherein the total mass of the lithium cobalt oxide is greater than the total mass of the olivine-type lithium phosphate compound.

14. The non-aqueous electrolyte battery according to claim 11, wherein the total mass of the lithium cobalt oxide is greater than the total mass of the olivine-type lithium phosphate compound.

15. The non-aqueous electrolyte battery according to claim 12, wherein the total mass of the lithium cobalt oxide is greater than the total mass of the olivine-type lithium phosphate compound.

16. The non-aqueous electrolyte battery according to claim 7, wherein the lithium cobalt oxide is present in the outermost positive electrode layer.

17. The non-aqueous electrolyte battery according to claim 8, wherein the lithium cobalt oxide is present in the outermost positive electrode layer.

18. The non-aqueous electrolyte battery according to claim 9, wherein the lithium cobalt oxide is present in the outermost positive electrode layer.

19. The non-aqueous electrolyte battery according to claim 10, wherein the lithium cobalt oxide is present in the outermost positive electrode layer.

20. The non-aqueous electrolyte battery according to claim 1, further comprising a battery case for accommodating a power-generating element containing the positive and negative electrodes and the separator, the battery case being flexible.
